(19) United States
(12) Patent Application Publication
(10) Pub. No.: US 2014/0319777 A1
(43) Pub. Date: Oct. 30, 2014

(54) ROTATING DEVICE

(71) Applicant: SAMSUNG ELECTRO-MECHANICS JAPAN ADVANCED TECH. CO., Fujieda City (JP)

(72) Inventors: Ryusuke SUGIKI, Fujieda City (JP); Mitsuo KODAMA, Fujieda City (JP); Akira NISHIO, Fujieda City (JP)

(73) Assignee: SAMSUNG ELECTRO-MECHANICS JAPAN ADVANCED TECH. CO., Fujieda City (JP)

(21) Appl. No.: 14/263,925

(22) Filed: Apr. 28, 2014

(30) Foreign Application Priority Data
Apr. 30, 2013 (JP) 2013-095730

(51) Int. Cl. F16J 15/40

(52) U.S. Cl. CPC F16J 15/40
USPC 277/412; 277/411

(57) ABSTRACT

A rotating device includes a rotator on which a magnetic recording disk is to be mounted, and a stationary body that supports the rotator in a freely rotatable manner through a fluid dynamic bearing. A lubricant is continuously applied to a lubricant applied portion in a gap between the rotator and the stationary body and from a second capillary seal to a first capillary seal through a dynamic pressure generating portion of the fluid dynamic bearing. This rotating device is structured so as to reduce an amount of the lubricant spilled and eventually dissipated when shock of substantially 1200 G is applied to be less than 5% of the total amount of the lubricant.

### BACKGROUND OF THE INVENTION

1. Field of the Invention

The present invention relates to a rotating device that rotates a recording disk.

2. Description of the Related Art

Disk drive devices like hard disk drives are becoming compact and increasing the capacity, and are built in various electronic devices. In particular, disk drive devices are recently built in portable electronic devices, such as a laptop computer, a tablet terminal, and a portable music player.

For example, JP 2013-007469 A discloses a motor including a bearing that employs a fluid dynamic bearing mechanism.

Portable electronic devices are likely subjected to relatively large shock due to falling, etc., in comparison with stationary device like a desk top PC (Personal Computer). When shock is applied to an electronic device, such shock is also applied to a disk drive device built in the electronic device. Due to the application of shock, the lubricant of a fluid dynamic bearing may spill out from a gas-liquid interface. When the amount of spilled lubricant increases, it often negatively affects the performance of the disk drive device.

Such a technical problem is not only for disk drive devices but also other kinds of rotating devices.

The present invention has been made in view of the aforementioned circumstances, and it is an objective of the present invention to provide a rotating device that reduces an amount of spilled lubricant due to an application of shock.

### SUMMARY OF THE INVENTION

To accomplish the above objective, a first aspect of the present invention provides a rotating device that includes: a rotator on which a recording disk is to be mounted; a stationary body that supports the rotator in a freely rotatable manner; a dynamic pressure generating portion provided in a lubricant-retained area where a lubricant is to be retained in a gap between the rotator and the stationary body; two capillary seals opened at respective ends of the lubricant-retained area; a cover ring which rotates together with the rotator, and which covers an opening of either one of the two capillary seals; and a cap structure which is provided in a space between the cover ring and the one capillary seal, and which is structured to reduce an amount of the lubricant spilled from the capillary seal and eventually dissipated when shock of substantially 1200 G is applied so as to be less than 5% of a total amount of the lubricant.

To accomplish the above objective, a second aspect of the present invention provides a rotating device that includes: a rotator on which a recording disk is to be mounted; a stationary body that supports the rotator in a freely rotatable manner; a dynamic pressure generating portion provided in a lubricant-retained area where a lubricant is to be retained in a gap between the rotator and the stationary body; two capillary seals opened at respective ends of the lubricant-retained area; a cover ring which rotates together with the rotator, and which covers an opening of either one of the two capillary seals; a narrowed structure which is provided in a space between the cover ring and the one capillary seal, and which has a gap becoming narrower than an open width of the one capillary seal to suppress a travel of the lubricant; wherein the narrowed structure includes: two surfaces facing with each other in a radial direction; one of the two surfaces comprises an upraised portion upraised toward the other surface; and an extending portion that extends from the other surface toward the upraised portion in the radial direction.

To accomplish the above objective, a third aspect of the present invention provides a rotating device that includes: a rotator on which a recording disk is to be mounted; a stationary body that supports the rotator in a freely rotatable manner; a dynamic pressure generating portion provided in a lubricant-retained area where a lubricant is to be retained in a gap between the rotator and the stationary body; two capillary seals opened at respective ends of the lubricant-retained area; and a cover ring which rotates together with the rotator, and which covers an opening of either one of the two capillary seals, wherein at least either one of the two capillary seals includes a suppressor located outwardly relative to an area where the lubricant is to be present, the suppressor being structured to suppress a travel of the lubricant.

Any combination of the aforementioned structural elements and mutual replacement of the structural elements of the present invention and expressions thereof between a method, a device, and a system are also advantageous as an aspect of the present invention.

### BRIEF DESCRIPTION OF THE DRAWINGS

FIGS. 1A to 1C are each a diagram illustrating a rotating device according to a first embodiment;

FIG. 2 is a cross-sectional view taken along a line A-A in FIG. 1C;

FIG. 3 is an enlarged cross-sectional view illustrating a bearing section in FIG. 2 in an enlarged manner;

FIG. 4 is a semi cross-sectional view of a motor section of a rotating device according to a second embodiment;

FIG. 5 is an exemplary diagram illustrating a cross section of an area of the rotating device where a lubricant is applied between a third capillary seal and a fourth capillary seal;

FIG. 6 is a semi cross-sectional view illustrating a motor section of a rotating device according to a third embodiment; and

FIG. 7 is an enlarged cross-sectional view illustrating a nearby portion of a shaft ring in FIG. 6 in an enlarged manner.

### DETAILED DESCRIPTION OF THE PREFERRED EMBODIMENTS

In the following explanation, the same or corresponding structural element and component illustrated in respective figures will be denoted by the same reference numeral, and the duplicated explanation thereof will be omitted accordingly. The dimension of the component illustrated in the respective figures is enlarged or scaled down as needed to facilitate understanding to the present invention. In addition, a part of the component in the respective figures not important to explain the embodiments will be illustrated in an omitted manner.

A rotating device according to embodiments is suitable applied as a disk drive device like a hard disk drive on which a magnetic recording disk is mounted and which rotates and drive such a disk. In particular, the rotating device of the embodiments is suitable applied as a fixed-shaft type disk drive device which has a shaft fastened to a base, and which has a hub rotatable relative to the shaft.

A rotating device of the embodiments includes a rotator on which a magnetic recording disk is to be mounted, and a stationary body that supports the rotator in a freely rotatable manner through a fluid dynamic bearing. In gaps between the rotator and the stationary body, a lubricant is continuously applied to a portion from one capillary seal to the other capillary seal through dynamic pressure generating portions of the fluid dynamic bearing. This rotating device has at least one of the following three features to reduce an amount of spilled lubricant when shock is applied:

(1) a damper area provided in the lubricant applied area and attenuating shock wave transmitted through the interior of the lubricant applied area;

(2) a narrowed vent of a capillary seal; and

(3) a mechanism provided so as to trap a lubricant come out from the capillary seal.

In particular, according to the rotating device of the embodiments, a structure is employed in which the amount of spilled lubricant when shock of substantially 1200 G is applied becomes smaller than 5% of the net amount of the lubricant.

Accordingly, because the amount of lubricant spilled and lost when shock is applied to the rotating device can be reduced, a reduction of the lifetime of the rotating device due to shock can be suppressed, while at the same time, an adherence of the lubricant to a magnetic recording disk 8 can be suppressed. Therefore, a rotating device that is suitable for, in particular, portable electronic devices is provided.

As an example case, when the amount of the lubricant becomes half, it becomes to negatively affect the rotation performance of rotating devices. In addition, as an example case, it is necessary to suppress an adverse effect to the rotation performance even if shock of substantially 1200 G is applied ten times in order to let a rotating device built in a portable electronic device. The rotating device of the embodiments can meet such requirements. That is, according to the embodiments, when shock of substantially 1200 G is applied ten times, the amount of spilled lubricant is smaller than 5%×10 times=50%, and thus the rotation performance can be maintained. In view of a safety margin, the rotating device may be configured in such a way that the amount of spilled lubricant when shock of substantially 1200 G is applied becomes smaller than 2% of the net amount of the lubricant. Still further, when a further strict condition is required in which no adverse effect acts on the rotation performance even if shock of substantially 1200 G is applied ten times to each of six surfaces of the rotating device, the rotating device may be configured in such away that the amount of spilled lubricant when shock of substantially 1200 G is applied becomes smaller than 0.8% of the net amount of the lubricant.

### First Embodiment

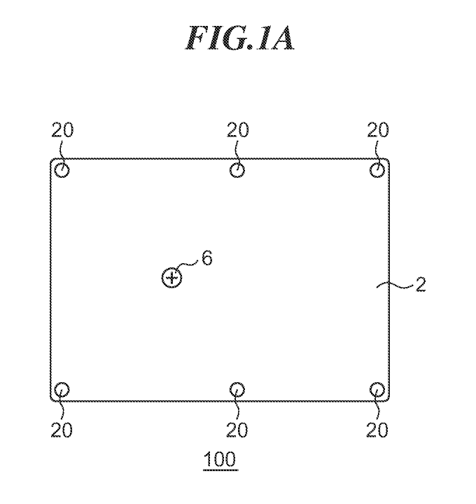

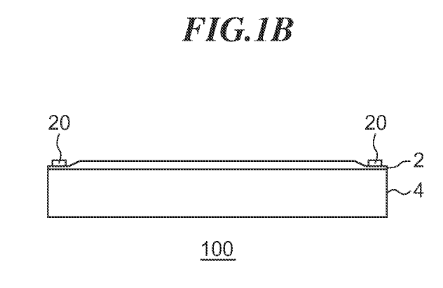

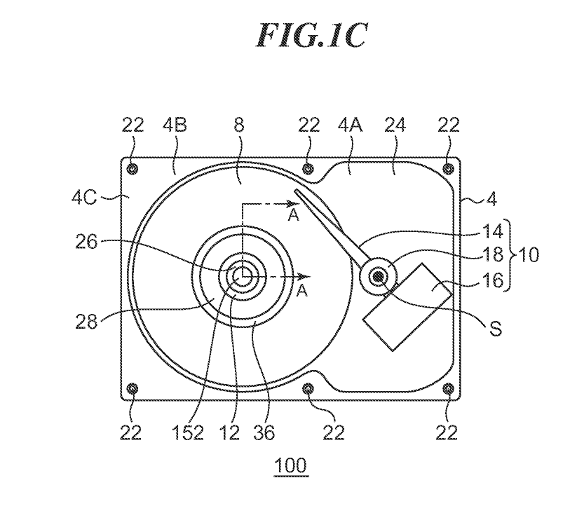

FIGS. 1A to 1C are each a diagram illustrating a rotating device 100 according to a first embodiment. FIG. 1A is a top view of the rotating device 100. FIG. 1B is a side view of the rotating device 100. FIG. 1C is a top view of the rotating device 100 with a top cover 2 being detached. The rotating device 100 includes a stationary body, a rotator rotatable relative to the stationary body, a magnetic recording disk 8 to be attached to the rotator, and a data reader/writer 10. The stationary body includes a base 4, a shaft 26 fastened to the base 4, the top cover 2, six screws 20, and a shaft fastening screw 6. The rotator includes a hub 28, a clamper 36, and a cover ring 12.

In the following explanation, a side at which the hub 28 is mounted relative to the base 4 will be defined as an upper side.

The magnetic recording disk 8 is, for example, a 2.5-inch magnetic recording disk formed of glass and having a diameter of 65 mm. The diameter of a center hole is 20 mm, and the thickness is 0.65 mm. One magnetic recording disk 8 is to be mounted on the hub 28.

The base 4 is formed and shaped by, for example, die-casting of an aluminum alloy. The base 4 includes a bottom portion 4A forming the bottom of the rotating device 100, and an outer circumference wall 4B formed along the outer circumference of the bottom portion 4A so as to encircle an area where the magnetic recording disk 8 is mounted. For example, six screw holes 22 are provided in an upper face 4C of the outer circumference wall 4B. The base 4 may be formed by pressing of a steel sheet or an aluminum sheet.

A surface coating is applied to the base 4 in order to suppress a peeling from the surface of the base 4. An example surface coating applied is a resin-material coating like an epoxy resin. Alternatively, a metal material, such as nickel or chrome, may be applied as the surface coating by plating. In this embodiment, the base 4 has the surface having undergone electroless nickel plating. In comparison with a case in which the resin material is applied as a coating, the surface hardness is enhanced to decrease a friction coefficient. Hence, when, for example, the magnetic recording disk 8 contacts the surface of the base 4 at the time of manufacturing, the possibility that the surface of the base 4 and the magnetic recording disk 8 are damaged can be reduced. In this embodiment, the surface of the base 4 has a static friction coefficient is within a range from 0.1 to 0.6. In comparison with a case in which the static friction coefficient is equal to or greater than 2, the possibility that the base 4 and the magnetic recording disk 8 are damaged can be further reduced.

The data reader/writer 10 includes an unillustrated recording/playing head, a swing arm 14, a voice coil motor 16, and a pivot assembly 18. The recoding/playing head is attached to the tip of the swing arm 14, records data in the magnetic recording disk 8, or reads the data therefrom. The pivot assembly 18 supports the swing arm 14 in a swingable manner to the base 4 around a head rotating shaft S. The voice coil motor 16 allows the swing arm 14 to swing around the head rotating shaft S to move the recording/playing head to a desired location over the top face of the magnetic recording disk 8. The voice coil motor 16 and the pivot assembly 18 are configured by conventionally well-known technologies of controlling the position of a head.

The top cover 2 covers the rotator. The top cover 2 is fastened to the upper face 4C of the outer circumference wall 4B of the base 4 using, for example, six screws 20. The six screws 20 correspond to the six screw holes 22, respectively. In particular, the top cover 2 and the upper face 4C of the outer circumference wall 4B are fastened together in such a way that no leak to the interior of the rotating device 100 occurs from the joined portion therebetween. The interior of the rotating device 100 is, more specifically, a clean space 24 surrounded by the bottom portion 4A of the base 4, the outer circumference wall 4B thereof, and the top cover 2. This clean space 24 is designed so as to be air-tightly sealed, i.e., so as to have no leak-in from the exterior and leak-out to the exterior. The clean space 24 is filled with a clean filler gas having particles eliminated. Accordingly, foreign materials like particles are prevented from sticking to the magnetic recording disk 8, thereby enhancing the operation reliability of the rotating device 100. An example filler gas is a gas with a smaller molecular weight than nitrogen, such as helium or hydrogen.

The shaft 26 runs along a rotation axis of the hub 28. A shaft-fastening-screw hole 152 is formed in the upper end face of the shaft 26. The shaft fastening screw 6 passes all the way through the top cover 2, and is engaged with the shaft-fastening-screw hole 152 by screwing, thereby fastening the top cover 2 to the shaft 26.

According to the rotating device having both ends of the shaft 26 fixed to the chassis including the top cover 2 and the base 4 as explained above among fixed-shaft type rotating devices, the shock resistance of the rotating drive device and the vibration resistance thereof can be enhanced. In addition, the NRRO (Non-Repeatable RunOut) can be reduced. Still further, the rigidity when the rotating device is held by fingers in the thickness direction can be enhanced. According to the rotating device of this type, however, when a fluid dynamic bearing is employed, there are two gas-liquid interfaces in general, and there is a possibility that the lubricant is spilled out from the respective gas-liquid interfaces.

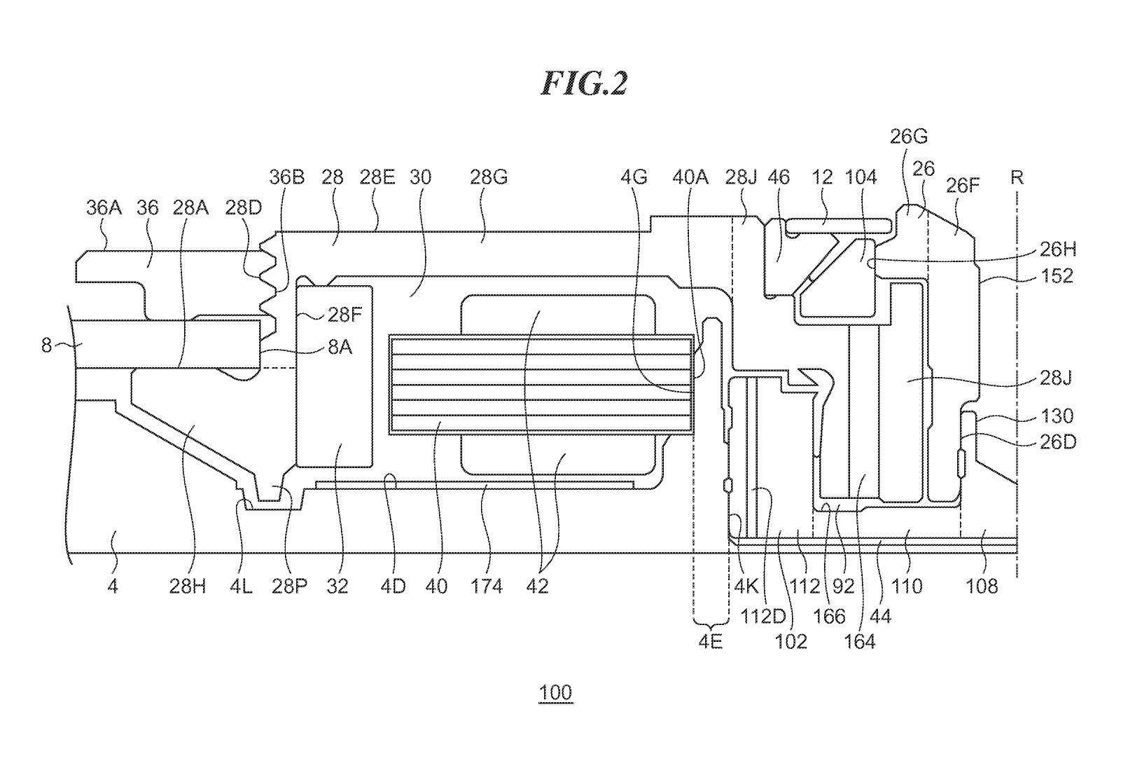

FIG. 2 is a cross-sectional view taken along a line A-A in FIG. 1C. The cross section illustrated in FIG. 2 corresponds to a half cross section of a motor component in the rotating device 100.

The rotator includes the hub 28, the clamper 36, a cylindrical magnet 32, the cover ring 12, and a ring support 46. The stationary body includes the base 4, a laminated core 40, coils 42, a housing 102, the shaft 26, and a shaft ring 104. A lubricant 92 is continuously present in some gaps between the rotator and the stationary body.

The hub 28 is formed by, for example, cutting and machining or pressing a ferrous material with a soft magnetism like SUS 430, and is formed in a predetermined shape like a substantially cup shape. In order to suppress a peeling from the surface of the hub 28, a surface layer forming process like electroless nickel plating may be applied to the surface of the hub 28.

The hub 28 includes a shaft encircling portion 28J that encircles the shaft 26, a hub protrusion 28G that is provided outwardly in the radial direction relative to the shaft encircling portion 28J, and to be engaged with the center hole 8A of the magnetic recording disk 8, and, a mount portion 28H provided outwardly in the radial direction relative to the hub protrusion 28G. The magnetic recording disk 8 is to be mounted on a disk mount face 28A that is the upper face of the mount portion 28H. The magnetic recording disk 8 is held between the clamper 36 and the mount portion 28H, thereby being fastened to the hub 28.

The clamper 36 applies downward force in the axial direction to the upper face of the magnetic recording disk 8 to cause the magnetic recording disk 8 to be in contact with the disk mount face 28A in a pressed manner against it. The clamper 36 is engaged with an outer circumference 28D of the hub protrusion 28G. The clamper 36 and the outer circumference 28D of the hub protrusion 28G can be joined together by mechanical joining techniques, such as screwing, caulking, and press-fitting, or a magnetic joining technique utilizing magnetic suction force.

The clamper 36 is disposed in such a way that, with the clamper 36 applying desired downward force to the magnetic recording disk 8, an upper face 36A of the clamper 36 does not protrude beyond an upper face 28E of the hub protrusion 28G.

When, for example, the clamper 36 and the outer circumference 28D of the hub protrusion 28G are engaged by screwing, a male screw is formed on the outer circumference 28D of the hub protrusion 28G, while a counterpart female screw is formed in an inner circumference 36B of the clamper 36. In this case, depending on the strength of the screwing, the tension of the downward force applied by the clamper 36 to the upper face of the magnetic recording disk 8 can be relatively precisely adjusted to desired tension. The clamper 36 may be formed of multiple pieces, or may be a single piece.

When process burrs are sticking to the outer circumference 28D of the hub protrusion 28G, the clamper 36 may contact the process burrs and the process burrs are peeled when the clamper 36 is engaged with the outer circumference 28D by screwing. In order to eliminate such process burrs beforehand, a burr eliminating process may be applied to the outer circumference 28D of the hub protrusion 28G.

An annular gate projection 28P protruding toward the base 4 is formed on the lower face of the mount portion 28H. A gate recess 4L where the gate projection 28P enters is formed in an upper face 4D of the base 4. Gas dynamic pressure generating grooves that generate inward dynamic pressure to a gas present in a gap between the gate projection 28P and the gate recess 4L when the hub 28 rotates are formed in the lower face of the gate projection 28P. The gas dynamic pressure generating grooves are formed in, for example, a spiral shape. The gate projection 28P and the gate recess 4L form a flow-out regulator that regulates a flow-out of the gas present in a motor internal space 30 held between the hub 28 and the base 4 to the exterior. This prevents the mist of lubricant 92, vaporized from a first gas-liquid interface 116 to be discussed later and reaching the motor internal space 30 therefrom, from reaching the magnetic recording disk 8.

The cylindrical magnet 32 is bonded and fastened to a cylindrical inner circumference 28F of the hub 28 corresponding to the internal cylindrical face thereof. The cylindrical magnet 32 is formed of, for example, a rare-earth magnetic material or a ferrite magnetic material. In this embodiment, the cylindrical magnet 32 is formed of a neodymium-based rare-earth magnetic material. The cylindrical magnet 32 has, for example, 12 driving polarities in the circumferential direction thereof (a tangent line direction of a vertical circle to the rotation axis R and around it). The cylindrical magnet 32 faces, for example, nine salient poles of the laminated core 40 in the radial direction (i.e., a direction orthogonal to the rotation axis R).

The laminated core 40 includes an annular part and the nine salient poles extending therefrom outwardly in the radial direction, and is fixed on an upper-face-4D side of the base 4. The laminated core 40 is formed by, for example, laminating six thin magnetic steel sheets each having a thickness of 0.2 mm, and caulking and integrating those sheets together. The laminated core 40 may be formed by laminating, for example, 2 to 20 thin magnetic steel sheets each having a thickness of 0.1 to 0.8 mm. An insulation coating is applied to the surface of the laminated core 40 by, for example, electrodeposition coating or powder coating. A coil 42 is wound around each salient pole of the laminated core 40. When three-phase substantially sinusoidal drive currents are caused to flow through the respective coils 42, drive magnetic fluxes are generated along the respective salient poles.

The base 4 includes an annular base protrusion 4E around the rotation axis R of the rotator. The base protrusion 4E protrudes upwardly so as to encircle the housing 102. When a center hole 40A of the annular part of the laminated core 40 is engaged with an outer circumference 4G of the base protrusion 4E, the laminated core 40 is fixed to the base 4. In particular, the annular part of the laminated core 40 is bonded and fixed to the base protrusion 4E by press-fitting or loose fitting. In this embodiment, in order to suppress a vibration of the laminated core 40, 60 to 90% of the thickness dimension of the annular part of the laminated core 40 in the axial direction contacts the outer circumference to the base protrusion 4E in a pressed manner against it.

A bearing recess 4K that is a non-through-hole around the rotation axis R is formed in the upper face 4D of the base 4. The housing 102 is retained in the bearing recess 4K. Since the bearing recess 4K is a non-through-hole, portions where leaks possibly occur can be reduced in comparison with a case of a through-hole. Hence, a contamination of external air with the clean space 24 can be prevented.

Portions of the upper face 4D of the base 4 corresponding to the salient poles and the coils 42 are provided with a resin-made insulating sheet or tape 174 like PET.

The housing 102 includes a flat and annular housing bottom 110, a cylindrical base-side encircling portion 112 fixed to the outer circumference of the housing bottom 110, and a supportive protrusion 108 fixed to the inner circumference of the housing bottom 110 and extending along the rotation axis R. The housing 102 forms an annular recess 166 where the lower end of the shaft encircling portion 28J enters together with the shaft 26.

The base-side encircling portion 112 is encircled by the base protrusion 4E. The base-side encircling portion 112 is fitted in the bearing recess 4K formed in the base 4, and is fixed to, in particular, the bearing recess 4K by a bond. A gas communication orifice 112D passing all the way through the base-side encircling portion 112 along the axial direction is formed therein. One end of the gas communication orifice 112D is opened to the motor internal space 30, while the other end is opened to a bottom space 44 between the housing 102 and the bottom of the bearing recess 4K. The gas communication orifice 112D serves for extracting gas when the housing 102 is fitted in the bearing recess 4K.

The bottom space 44 is inevitably formed when the housing 102 is fitted in the bearing recess 4K that is a non-through-hole. When the rotating device 100 is manufactured, in order to maintain the cleanness of the clean space 24, it is necessary to also replace the gas in the bottom space 44 with clean gas. Hence, by providing the gas communication orifice 112D, the motor internal space 30 and the bottom space 44 are caused to be in communication with each other, and thus replacement of the gas in the bottom space 44 with clean gas is enabled.

A support hole 26D is formed in the lower end face of the shaft 26 along the rotation axis R. The shaft-fastening-screw hole 152 and the support hole 26D are in communication with each other. The supportive protrusion 108 is fitted in and fastened to the support hole 26D. In particular, the supportive protrusion 108 is fastened to the support hole 26D by both press-fitting and bonding. A non-through-hole screw catching hole 130 is formed in the upper end face of the supportive protrusion 108 along the rotation axis R.

The shaft fastening screw 6 is engaged with the shaft-fastening-screw hole 152 in a screwed manner, while at the same time, passes all the way through the shaft-fastening-screw hole 152. The lower end of the shaft fastening screw 6 enters the screw catching hole 130, and is bonded and fastened thereto. That is, a bond is present between the shaft fastening screw 6 and the supportive protrusion 108. The screw catching hole may be a threaded hole, and the shaft fastening screw 6 may be engaged with the screw catching hole 130 in a screwed manner.

The shaft 26 includes a body 26F extending along the rotation axis R, and a flange 26G extending outwardly in the radial direction from the upper end of the body 26F.

The shaft ring 104 is fixed to an outer circumference 26H of the flange 26G so as to encircle the flange 26G. The shaft ring 104 is fixed to the flange 26G by both press-fitting and bonding. A bond between the shaft ring 104 and the flange 26G seals a space between the shaft ring 104 and the flange 26G, and serves as a sealant that suppresses a leakage of the lubricant 92.

The lubricant 92 contains a fluorescent material. When the lubricant 92 is irradiated with light like ultraviolet rays, the lubricant 92 emits, for example, blue or green light with a different wavelength from the emitted light because of the fluorescent material. Since the lubricant 92 contains the fluorescent material, the liquid level of the lubricant 92 can be easily inspected. In addition, it is also possible to easily inspect an adherence and a leak-out of the lubricant 92.

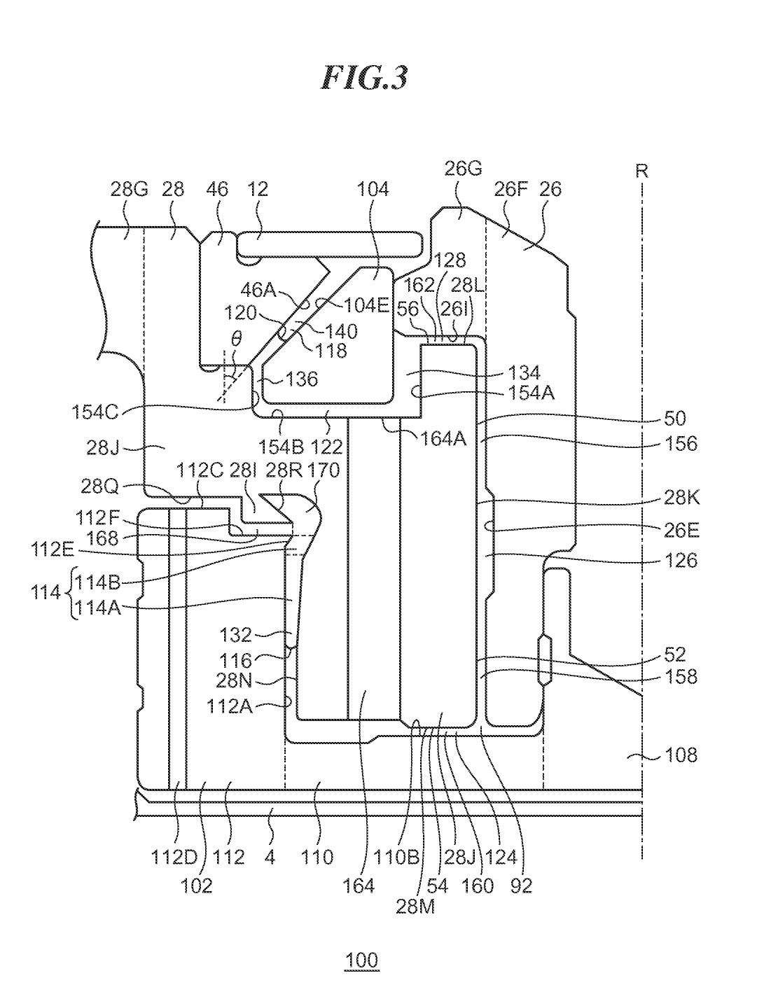

FIG. 3 is an enlarged cross-sectional view illustrating a bearing portion in FIG. 2 in an enlarged manner. The shaft encircling portion 28J encircles the body 26F. The lubricant 92 is present between the shaft encircling portion 28J and the body 26F. That is, an inner circumference 28K of the shaft encircling portion 28J and an outer circumference 26E of the body 26F face with each other via a first gap 126 to which the lubricant 92 is applied.

The shaft encircling 28J is held between the flange 26G and the shaft ring 104, and, the housing 102 in the axial direction (i.e., the direction parallel to the rotation axis R). The lubricant 92 is present between the shaft encircling portion 28J and the shaft ring 104, between the shaft encircling portion 28J and the flange 26G, and between the shaft encircling portion 28J and the housing 102. That is, a flange opposing face 28L of the shaft encircling portion 28J faces a lower face 26I of the flange 26G with a second gap 128 to which the lubricant 92 is applied. A lower face 28M of the shaft encircling portion 28J faces an upper face 110B of the housing bottom 110 via a third gap 124 to which the lubricant 92 is applied.

The first gap 126 includes two radial dynamic pressure generating portions 156 and 158 that generate dynamic pressure in the radial direction to the lubricant 92 when the hub 28 rotates relative to the shaft 26. The two radial dynamic pressure generating portions 156 and 158 are spaced apart from each other in the axial direction, and the first radial dynamic pressure generating portion 156 is located above the second radial dynamic pressure generating portion 158. Formed in portions of an inner circumference 28K of the shaft encircling portion 28J corresponding to the two radial dynamic pressure generating portions 156, 158 are first radial dynamic pressure generating grooves 50 and second radial dynamic pressure generating grooves 52 in a herringbone or spiral shape. At least one of the first and second radial dynamic pressure generating grooves 50 and 52 may be formed in an outer circumference 26E of the body 26F instead of the inner circumference 28K of the shaft encircling portion 28J.

The third gap 124 includes a first thrust dynamic pressure generating portion 160 that generates dynamic pressure in the axial direction to the lubricant 92 when the hub 28 rotates relative to the shaft 26. Formed in portion of the lower face 28M of the shaft encircling portion 28J corresponding to the first thrust dynamic pressure generating portion 160 are first thrust dynamic pressure generating grooves 54 in a herringbone or spiral shape. The first thrust dynamic pressure generating grooves 54 may be formed in the upper face 110B of the housing bottom 110 instead of the lower face 28M of the shaft encircling portion 28J.

The second gap 128 includes a second thrust dynamic pressure generating portion 162 that generates dynamic pressure in the axial direction to the lubricant 92 when the hub 28 rotates relative to the shaft 26. Formed in a portion of the flange opposing face 28L of the shaft encircling portion 28J corresponding to the second thrust dynamic pressure generating portion 162 are second thrust dynamic pressure generating grooves 56 in a herringbone or spiral shape. The second thrust dynamic pressure generating grooves 56 may be formed in the lower face 26I of the flange 26G instead of the flange opposing face 28L of the shaft encircling portion 28J.

When the rotator rotates relative to the stationary body, the first and second radial dynamic pressure generating grooves 50, 52 and the first and second thrust dynamic pressure generating grooves 54, 56 produce dynamic pressures to the lubricant 92, respectively. Such dynamic pressures support the rotator in the radial direction and the axial direction in a non-contact manner with the stationary body.

As to a positional relationship between the base-side encircling portion 112 and the shaft encircling portion 28J, the base-side encircling portion 112 encircles a lower part of the shaft encircling portion 28J. Formed between the base-side encircling portion 112 and the shaft encircling portion 28J is a first tapered seal 114 where a fourth gap 132 between an inner circumference 112A of the base-side encircling portion 112 and a lower outer circumference 28N of the shaft encircling portion 28J becomes gradually widespread toward the upper space. The first tapered seal 114 has a first gas-liquid interface 116 of the lubricant 92, and suppresses a leak-out of the lubricant 92 by a capillary phenomenon.

The first capillary seal 114 includes a tapered area 114A where the first gas-liquid interface 116 is present when the rotator rotates relative to the stationary body, and a narrowed area 114B which is provided at a side of the first gas-liquid interface 116 where the gas is present so as to be in communication with the tapered area 114A, and which suppresses a travel of the lubricant 92. The narrowed area 114B has a gap narrower than the maximum gap of the tapered area 114A, thereby suppressing a travel of the lubricant 92. A lubricant return 112E that is upraised toward the lower part of the outer circumference 28N of the shaft encircling portion 28J is provided at a part of an inner circumference 112A of the base-side encircling portion 112 forming the narrowed area 114B. In particular, the lubricant return 112E is formed so as to at least partially cover the first gas-liquid interface 116 as viewed from in the axial direction. The minimum value of the gap of the narrowed area 114B in the radial direction is smaller than the maximum value of the gap of the tapered area 114A in the radial direction.

An annular labyrinth recess 112F is formed in an upper face 112C of the base-side encircling portion 112. A labyrinth projection 28I that enters the labyrinth recess 112F is formed on an opposing face 28Q of the shaft encircling portion 28J facing the upper face 112C of the base-side encircling portion 112 in the axial direction. The labyrinth recess 112F and the labyrinth projection 28I form a labyrinth seal 168 to the vaporized lubricant 92. The labyrinth seal 168 is in communication with the narrowed area 114B through a lubricant trap 170 that has a wider gap than the gap of the labyrinth seal 168.

When the rotator rotates relative to the stationary body, the lubricant trap 170 traps the travelling lubricant 92 from the first gas-liquid interface 116 by centrifugal force. The lubricant trap 170 is an internal annular space relative to the labyrinth projection 28I, and includes a recess concaved upwardly and provided in the shaft encircling portion 28J. An inner circumference 28R of the labyrinth projection 28I, i.e., a surface defining the lubricant trap 170 is tapered so as to increase the outer diameter from the top to the bottom. At least a part of the lubricant 92 spilled out from the first gas-liquid interface 116 is trapped in the lubricant trap 170. The lubricant 92 in the lubricant trap 170 is held at the corner of the basal end of the labyrinth projection 28I due to centrifugal force when the rotator is rotating.

An annular sleeve recess is formed in the upper portion of the shaft encircling portion 28J around the rotation axis R. The sleeve recess is concaved downwardly. The sleeve recess includes a first concaved face 154A that extends downwardly in the axial direction from the outer circumferential edge of the flange opposing face 28L, a second concaved recess 154B that extends substantially in parallel with the radial direction from the lower end edge of the first concaved face 154A, and a third concaved face 154C that extends upwardly in the axial direction from the outer circumferential edge of the second concaved face 154B. The shaft ring 104 at least partially enters the sleeve recess.

The ring support 46 is encircled by the upper portion of the shaft encircling portion 28J, and is fixed to that upper portion. The ring support 46 and the shaft ring 104 face with each other, and a support-side opposing face 46A of the ring support 46 facing the shaft ring 104 is formed as a conical side face around the rotation axis R. A ring-side opposing face 104E of the shaft ring 104 facing the support-side opposing face 46A is formed as a conical side face around the rotation axis R. The support-side opposing face 46A is located outwardly relative to the ring-side opposing face 104E. An angle θ between the slope of support-side opposing face 46A and the rotation axis R is set to be between 30 to 60 degrees. The angle between the slope of the ring-side opposing face 104E and the rotation axis R is larger than the angle θ.

A ninth gap 140 between the support-side opposing face 46A and the ring-side opposing face 104E forms a second capillary seal 118 that gradually becomes widespread toward the oblique upward space. The second capillary seal 118 includes a second gas-liquid interface 120 of the lubricant 92, and suppresses a leakage of the lubricant 92 by a capillary phenomenon.

The fourth gap 132, the third gap 124, the first gap 126, the second gap 128, a fifth gap 134 formed by the first concaved face 154A and the shaft ring 104 facing with each other in the radial direction, a sixth gap 122 formed by the second concaved face 154B and the shaft ring 104 facing with each other in the axial direction, a seventh gap 136 formed by the third concaved face 154C and the shaft ring 104 facing with each other in the radial direction, and the ninth gap 140 are linked together in series in this order, and the lubricant 92 is continuously present in those gaps.

Formed in the shaft encircling portion 28J is a bypass communication orifice 164 which is opened to the sixth gap 122, and which bypasses the two thrust dynamic pressure generating portions 160, 162, and the two radial dynamic pressure generating portions 156, 158. The upper end of the bypass communication orifice 164 is opened to the sixth gap 122, while the lower end of the bypass communication orifice 164 is opened at a portion outwardly relative to the first thrust dynamic pressure generating portion 160 in the third gap 124. The lubricant 92 is filled in the bypass communication orifice 164, and when, in particular, generated dynamic pressures are unbalanced, the lubricant 92 flows through the bypass communication orifice 164. This causes the generated dynamic pressures to be balanced. As a result, even if, for example, generated dynamic pressures are unbalanced, the level of the first gas-liquid interface 116 and that of the second gas-liquid interface 120 can be maintained.

The volume of the fifth gap 134 while the rotator is rotating is larger than a net volume of the volume of the first radial dynamic pressure generating portion 156, the volume of the second radial dynamic pressure generating portion 158, the volume of the first thrust dynamic pressure generating portion 160, and the volume of the second thrust dynamic pressure generating portion 162. The volume of the fifth gap 134 may be larger than the volume of the bypass communication orifice 164. The fifth gap 134, the sixth gap 122, and the seventh gap 136 are designed in such a way that the flow resistance between an upper end opening 164A of the bypass communication orifice 164 and the fifth gap 134 becomes smaller than the flow resistance between the opening 164A and the second capillary seal 118. The flow resistance may be an arbitrary factor in a flow channel which disturbs the flow of a fluid, and includes, for example, a surface roughness, a keen bentness, a scale-down, or a scale-enlargement.

In the sixth gap 122, a first channel reaching the seventh gap 136 from the upper end opening 164A of the bypass communication orifice 164 is longer than a second channel reaching the fifth gap 134 from the opening 164A. In particular, the fifth gap 134 and the bypass communication orifice 164 are disposed in series along the axial direction. At least some shock waves propagated through the bypass communication orifice 164 upwardly are output through the upper end opening 164A, enter the fifth gap 134, and attenuated therein. Hence, the fifth gap 134 serves as a damper for shock waves. Because of the difference in the flow resistance between the first path and the second path, the percentage of the shock waves attenuated as explained above in the fifth gap 134 becomes relatively high.

The fifth gap 134 also serves as a lubricant retainer that retains thereinside the lubricant 92.

The cover ring 12 is fixed to the ring support 46 by bonding so as to cover the second gas-liquid interface 120 present in the ninth gap 140. The cover ring 12 may be fixed to, instead of the rotator, for example, the flange 26G of the stationary body. The cover ring 12 is formed in an annular shape and of a metal material like stainless steel, or a resin material. The cover ring 12 may include a porous material like a sintered material, or a charcoal filter so as to trap the gas and mist of the lubricant 92 spilled from the second gas-liquid interface 120.

An explanation will now be given of an operation of the rotating device 100 employing the above-explained structure. Three-phase drive currents are applied to the coils 42 to rotate the magnetic recording disk 8. When such drive currents flow through the respective coils 42, magnetic fluxes are generated along the nine salient poles. Those magnetic fluxes apply torque to the cylindrical magnet 32, and thus the rotator and the magnetic recording disk 8 engaged therewith start rotating. While at the same time, when the voice coil motor 16 causes the swing arm 14 to swing, the recording/playing head goes out and comes in the swingable range over the magnetic recording disk 8. The recording/playing head converts magnetic data recorded in the magnetic recording disk 8 into electrical signals, and transmits the signals to a control board (unillustrated), or writes data transmitted in the form of electrical signals from the control board in the magnetic recording disk 8 as magnetic data.

According to the rotating device 100 of this embodiment, the amount of spilled lubricant 92 when shock is applied to the rotating device 100 can be reduced. In particular, when shock waves due to shock applied to the bottom face of the base 4 propagate through the bypass communication orifice 164 from the bottom to the upper portion thereof, most shock waves are attenuated in the fifth gap 134. Accordingly, shock wave that can reach the second capillary seal 118 can be weakened. As a result, the amount of lubricant 92 spilled from the second gas-liquid interface 120 due to shock can be reduced.

In addition, according to the rotating device 100 of this embodiment, as to the shape of the second capillary seal 118, the angle θ between the slope of the support-side opposing face 46A and the rotation axis R is within a range from 30 to 60 degrees. Accordingly, even if the droplets of the lubricant 92 are spilled to the upper space (a side where gas is present) of the second gas-liquid interface 120 in the second capillary seal 118 while the rotator is rotating, the droplets are returned to the second gas-liquid interface 120 by centrifugal force. Therefore, the amount of spilled lubricant 92 can be reduced.

Still further, according to the rotating device 100 of this embodiment, as to the shape of the first capillary seal 114, the narrowed area 114B that suppresses a travel of the lubricant 92 is provided at a side of the first gas-liquid interface 116 where gas is present. In particular, the narrowed area 114B has a narrowed gap. Hence, the lubricant 92 spilled from the first gas-liquid interface 116 due to application of shock is not likely to pass through the narrowed area 114B, thereby reducing the amount of spilled lubricant 92.

In particular, at least some lubricant 92 spilled from the first gas-liquid interface 116 due to application of shock hit the lubricant return 112E, and are returned to the first gas-liquid interface 116. Therefore, the amount of lubricant 92 can be reduced which are spilled out from the first gas-liquid interface 116 and leak from the labyrinth seal 168 and to the exterior.

Moreover, even if the spilled lubricant 92 is able to pass through the narrowed area 114B, at least some passing lubricant 92 are trapped by the lubricant trap 170. Therefore, the amount of lubricant 92 leaking from the labyrinth seal 168 and to the exterior thereof can be reduced.

### Second Embodiment

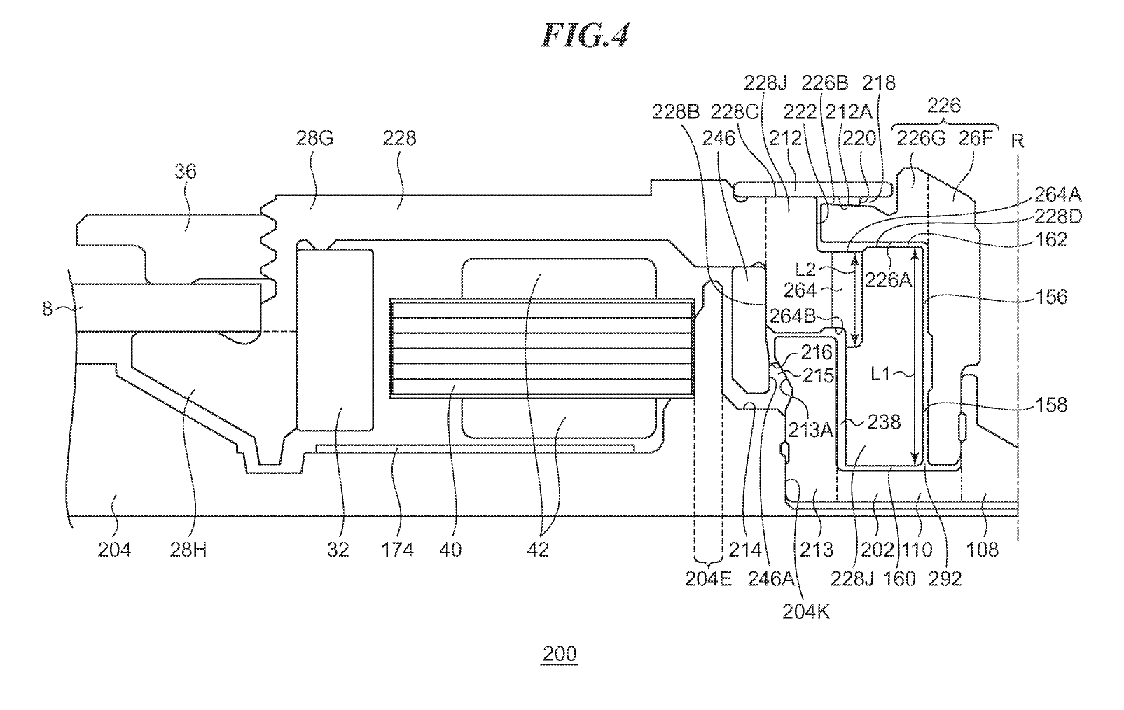

FIG. 4 is a semi cross-sectional view illustrating a motor section of a rotating device 200 according to a second embodiment. FIG. 4 corresponds to FIG. 2. The rotating device 200 includes a rotator on which a magnetic recording disk 8 is to be mounted, and a stationary body that supports the rotator in a freely rotatable manner through a fluid dynamic bearing. The rotator includes a hub 228, a clamper 36, a cylindrical magnet 32, a cover ring 212, and a seal former 246. The stationary body includes a base 204, a laminated core 40, coils 42, a housing 202, and a shaft 226. A lubricant 292 is continuously present in some gaps between the rotator and the stationary body.

The hub 228 includes a shaft encircling portion 228J that encircles the shaft 226, a hub protrusion 28G, and a mount portion 28H.

The base 204 includes an annular base protrusion 204E around a rotation axis R of the rotator. The base protrusion 204E protrudes upwardly so as to encircle the housing 202. When the center hole of the annular portion of the laminated core 40 is engaged with the outer circumference of the base protrusion 204E, the laminated core 40 is fastened to the base 204. A bearing recess 204K that is a non-through-hole is formed in the upper face of the base 204 around the rotation axis R. The housing 202 is retained in the bearing recess 204K.

The housing 202 includes a housing bottom 110, a cylindrical base-side encircling portion 213 which is fastened to the outer circumference of the housing bottom 110, and which encircles the lower portion of the shaft encircling portion 228J, and a supportive protrusion 108. The base-side encircling portion 213 is fixed to the bearing recess 204K by bonding.

The shaft 226 includes a body 26F, and a flange 226G extending outwardly in the radial direction from the upper end portion of the body 26F. The shaft encircling portion 228J encircles the body 26F. A gap between the shaft encircling portion 228J and the body 26F includes a first radial dynamic pressure generating portion 156 and a second radial dynamic pressure generating portion 158.

The shaft encircling portion 228J is held between the flange 226G and the housing 202 in the axial direction. A gap between the shaft encircling portion 228J and the flange 226G includes a second thrust dynamic pressure generating portion 162. A gap between the shaft encircling portion 228J and the housing bottom 110 includes a first thrust dynamic pressure generating portion 160.

The seal former 246 is attached to an outer circumference 228B of the shaft encircling portion 228J, and encircles the upper portion of the base-side encircling portion 213. The base protrusion 204E encircles the seal former 246. In other words, the base protrusion 204E and the base-side encircling portion 213 form a base recess 214, and the seal former 246 enters this base recess 214. The seal former 246 may be formed integral with the hub 228 in a seamless manner. In this case, a joining work can be eliminated.

Provided between the seal former 246 and the base-side encircling portion 213 is a third capillary seal 215 that is a portion having a gap between an inner circumference 246A of the seal former 246 and an outer circumference 213A of the base-side encircling portion 213 gradually becoming widespread downwardly. The third capillary seal 215 includes a third gas-liquid interface 216 of the lubricant 292. The base recess 214 corresponds to the labyrinth recess 112F of the first embodiment, and the lower portion of the seal former 246 corresponds to the labyrinth projection 28I of the first embodiment. The third capillary seal 215 is provided outwardly in the radial direction relative to a fourth capillary seal 218 to be discussed later.

The cover ring 212 is bonded to and fastened to an upper face 228C of the shaft encircling portion 228J. The cover ring 212 further protrudes inwardly from the internal edge of the upper face 228C of the shaft encircling portion 228J. The cover ring 212 and the shaft encircling portion 228J forms a seal recess 222 concaved along the radial direction. The flange 226G enters the seal recess 222.

Provided between the flange 226G and the cover ring 212 is a fourth capillary seal 218 that is a portion having a gap between an upper face 226B of the flange 226G and a lower face 212A of the cover ring 212 gradually becoming widespread toward the rotation axis R. The fourth capillary seal 218 extends along the radial direction. The fourth capillary seal 218 includes a fourth gas-liquid interface 220 of the lubricant 292. The fourth capillary seal 218 is provided at an opposite side to the second thrust dynamic pressure generating portion 162 across the flange 226G.

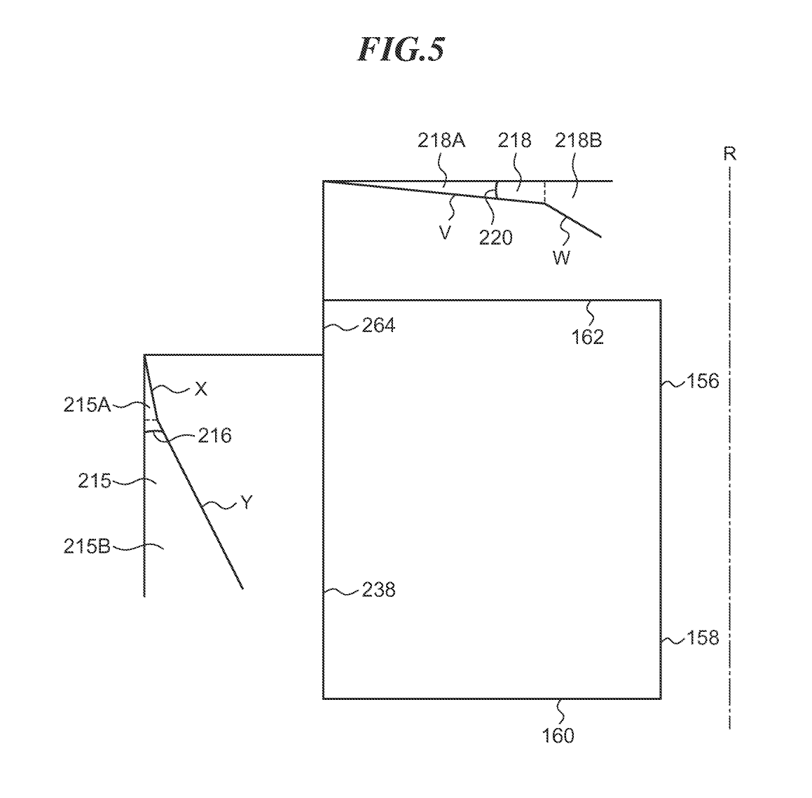

Next, an explanation will be given of a change rate of a capillary seal gap. FIG. 5 is an exemplary diagram illustrating a cross section where the lubricant is applied from the third capillary seal 215 of the rotating device 200 to the fourth capillary seal 218 thereof. In order to facilitate understanding, in FIG. 5, areas other than the capillary seal where the lubricant is applied are indicated by thick lines. In addition, in the following explanation, a change rate of a spacing of a gap relative to a change in a distance in a direction in which the capillary seal becomes widespread is referred to as a gap change rate.

According to the rotating device 200, the gap where the spacing of the fourth capillary seal 218 gradually becomes widespread toward the rotation axis R is designed in such a way that a gap change rate V of an external area 218A in the outward radial direction is smaller than a gap change rate W of an internal area 218B in the inward radial direction relative to the external area 218A. The gap change rate V of the external area 218A is, for example, within 3 to 7%, while the gap change rate W of the internal area 218B may be, for example, within 10 to 50%.

According to the rotating device 200, the gap where the spacing of the third capillary seal 215 gradually becomes widespread downwardly is designed in such a way that a gap change rate X of an upper area 215A is smaller than a gap change rate Y of a lower area 215B below the upper area 215A. The gap change rate X of the upper area 215A is, for example, within 3 to 7%, while the gap change rate Y of the lower area 215B may be, for example, within 10 to 50%.

According to the rotating device 200, the gap change rate Y of the lower area 215B of the third capillary seal 215 is larger than the gap change rate V of the external area 218A. In addition, the gap change rate W of the internal area 218B is larger than the gap change rate Y of the lower area 215B.

A bypass communication orifice 264 that bypasses the four dynamic pressure generating portions 156, 158, 160, 162 is formed in the shaft encircling portion 228J. An upper end opening 264A of the bypass communication orifice 264 is formed in an opposing face 228D of the shaft encircling portion 228J facing a lower face 226A of the flange 226G. In particular, this opening 264A is formed in a portion of the opposing face 228D outwardly relative to the second thrust dynamic pressure generating portion 162. A lower end opening 264B of the bypass communication orifice 264 is provided at a portion between an eighth gap 238 where the base-side encircling portion 213 and the lower portion of the shaft encircling portion 228J face with each other, and, the third capillary seal 215. A length L2 of the bypass communication orifice 264 is equal to or shorter than a half of a maximum length L1 of the shaft encircling portion 228J in the axial direction.

The volume of an eighth gap 238 while the rotator is rotating is larger than a net volume of the volume of the first radial dynamic pressure generating portion 156, the volume of the second radial dynamic pressure generating portion 158, the volume of the first thrust dynamic pressure generating portion 160, and the volume of the second thrust dynamic pressure generating portion 162. A flow resistance between the eighth gap 238 and the lower end opening 264B of the bypass communication orifice 264 is smaller than a flow resistance between the opening 264B and the third capillary seal 215. In particular, the eighth gap 238 and the bypass communication orifice 264 are provided in series along the axial direction. Hence, the eighth gap 238 has a similar damper function to that of the fifth gap 134 of the first embodiment.

According to the rotating device 200 of this embodiment, the amount of lubricant 292 spilled when shock is applied to the rotating device 200 can be reduced. When, in particular, shock wave due to shock applied to the upper face of the top cover 2 is transmitted through the bypass communication orifice 264 from the top to the bottom portion thereof, most shock wave enters the eighth gap 238 and attenuated. Hence, shock wave reaching the third capillary seal 215 can be weakened. As a result, the amount of lubricant 292 spilled from the third gas-liquid interface 216 by application of shock can be reduced.

In addition, according to the rotating device 200 of this embodiment, the fourth capillary seal 218 is formed in a shape that increases the gap as coming close to the rotation axis R along the radial direction. Hence, even if droplets of the lubricant 292 are spilled inwardly relative to the fourth gas-liquid interface 220 (to a side where gas is present) in the fourth capillary seal 218 while the rotator is rotating, the droplets are returned to the fourth gas-liquid interface 220 by centrifugal force. As a result, the amount of spilled lubricant 292 can be reduced.

Still further, according to the rotating device 200 of this embodiment, the bypass communication orifice 264 is provided at a location where the shaft encircling portion 228J becomes relatively thin. Hence, the bypass communication orifice 264 can be made relatively thick to maintain the effect of dynamic pressure equalization, while at the same time, the bypass communication orifice 264 can be made short to reduce the volume thereof. When the volume of the bypass communication orifice 264 can be reduced, shock wave applied to the lubricant 292 in the bypass communication orifice 264 when shock is applied can be weakened.

To apply the lubricant to the portion where the lubricant is to be filled, for example, a scheme of applying the lubricant to an opening that will be a capillary seal is applicable. In this case, when the area of the opening where the lubricant is applied is small, a work time necessary to apply a predetermined amount of lubricant becomes long in some cases.

According to the rotating device 200 of this embodiment, however, the third capillary seal 215 is provided outwardly in the radial direction relative to the fourth capillary seal 218. Hence, in comparison with a case in which the third capillary seal is provided inwardly, the area of the opening of the third capillary seal can be increased. This facilitates a work of applying the lubricant 292, and reduces the time necessary for such a work.

Yet further, according to the rotating device 200 of this embodiment, the fourth capillary seal 218 extends along the radial direction, and thus the dimension of the fourth capillary seal 218 in the axial direction can be reduced in comparison with a case in which the fourth capillary seal extends along the axial direction. As a result, the rotating device can be made thin by what corresponds to the thinning of the fourth capillary seal 218.

According to the rotating device 200 of this embodiment, the gap change rate Y of the lower area 215B of the third capillary seal 215 is larger than the gap change rate V of the external area 218A, and thus the dimension of the third capillary seal 215 in the axial direction can be reduced in the case of retaining the same amount of lubricant. In addition, the rotating device can be made thin by what corresponds to the thinning of the third capillary seal 215.

According to the rotating device 200 of this embodiment, the gap change rate W of the internal area 218B of the fourth capillary seal 218 is larger than the gap change rate Y of the lower area 215B of the third capillary seal 215. Hence, the volume of the fourth capillary seal 218 can be increased to increase a retainable amount of lubricant.

### Third Embodiment

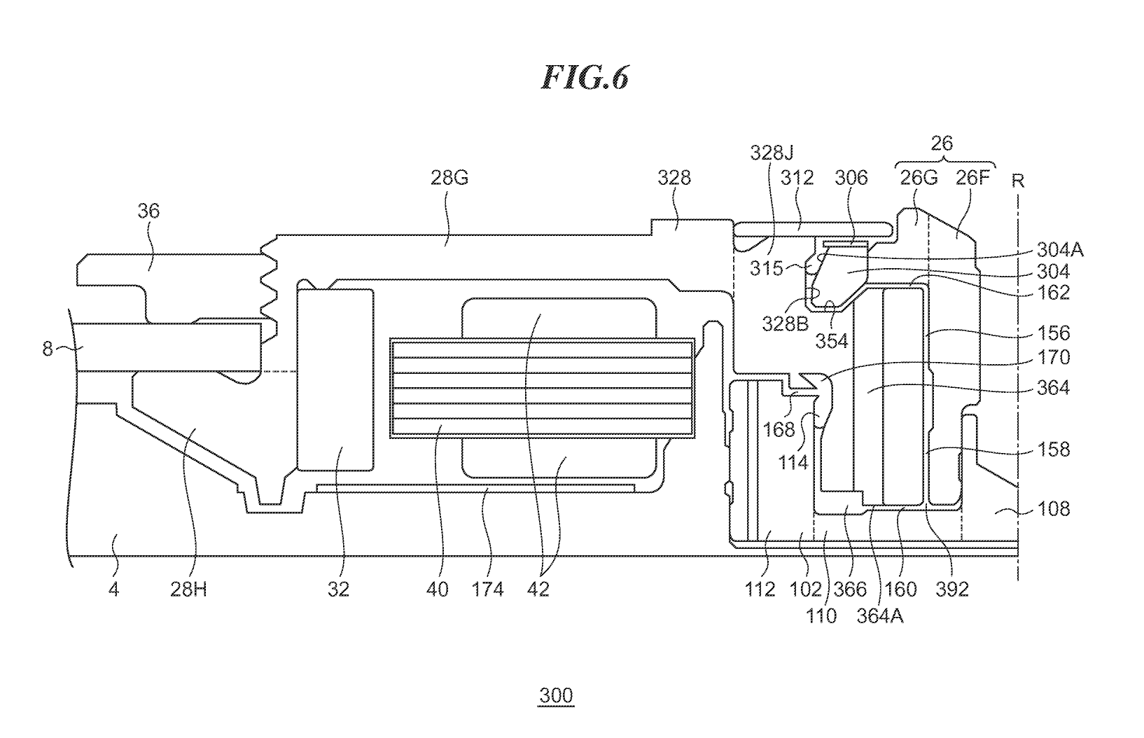

FIG. 6 is a semi cross-sectional view of a motor section of a rotating device 300 according to a third embodiment. FIG. 6 corresponds to FIG. 2. The rotating device 300 includes a rotator on which a magnetic recording disk 8 is to be mounted, and a stationary body that supports the rotator in a freely rotatable manner through a fluid dynamic bearing. The rotator includes a hub 328, a clamper 36, a cylindrical magnet 32, and a cover ring 312. The stationary body includes a base 4, a laminated core 40, coils 42, a housing 102, a shaft 26, a shaft ring 304, and a seal cap 306. A lubricant 392 is continuously present in some gaps between the rotator and the stationary body.

The hub 328 includes a shaft encircling portion 328J that encircles the shaft 26, a hub protrusion 28G, and amount portion 28H. The shaft encircling portion 328J encircles a body 26F. A gap between the shaft encircling portion 328J and the body 26F includes a first radial dynamic pressure generating portion 156 and a second radial dynamic pressure generating portion 158.

The shaft encircling portion 328J is held between a flange 26G, the shaft ring 304, and the housing 102 in the axial direction. A gap between the shaft encircling portion 328J and the flange 26G includes a second thrust dynamic pressure generating portion 162. A gap between the shaft encircling portion 328J and a housing bottom 110 includes a first thrust dynamic pressure generating portion 160.

As to a positional relationship between a base-side encircling portion 112 and the shaft encircling portion 328J, the base-side encircling portion 112 encircles the lower portion of the shaft encircling portion 328J. A first capillary seal 114 is formed between the base-side encircling portion 112 and the shaft encircling portion 328J.

A bypass communication orifice 364 that bypasses the four dynamic pressure generating portions 156, 158, 160, and 162 is formed in the shaft encircling portion 328J. The upper end of the bypass communication orifice 364 is opened at a portion between the second thrust dynamic pressure generating portion 162 and a fifth capillary seal 315 (to be discussed later), while the lower end of the bypass communication orifice 364 is opened at a portion between the first thrust dynamic pressure generating portion 160 and a first capillary seal 114.

A damper portion 366 outwardly relative to a lower end opening 364A of the bypass communication orifice 364 in the gap between the shaft encircling portion 328J and the housing bottom 110 has a volume that is larger than a net volume of the volume of the first radial dynamic pressure generating portion 156, the volume of the second radial dynamic pressure generating portion 158, the volume of the first thrust dynamic pressure generating portion 160, and the volume of the second thrust dynamic pressure generating portion 162. The damper portion 366 is located between the first capillary seal 114 and the lower end opening 364A of the bypass communication orifice 364. Hence, the flow resistance between the damper portion 366 and the opening 364A is smaller than the flow resistance between the opening 364A and the first capillary seal 114. Therefore, the damper portion 366 has the similar damper function to that of the fifth gap 134 of the first embodiment.

The cover ring 312 is fastened to the shaft encircling portion 328J by bonding so as to cover the fifth capillary seal 315.

The shaft ring 304 is fixed to the outer circumference of the flange 26G so as to encircle the flange 26G. An annular sleeve recess 354 around the rotation axis R is formed in the upper portion of the shaft encircling portion 328J. The shaft ring 304 enters the sleeve recess 354.

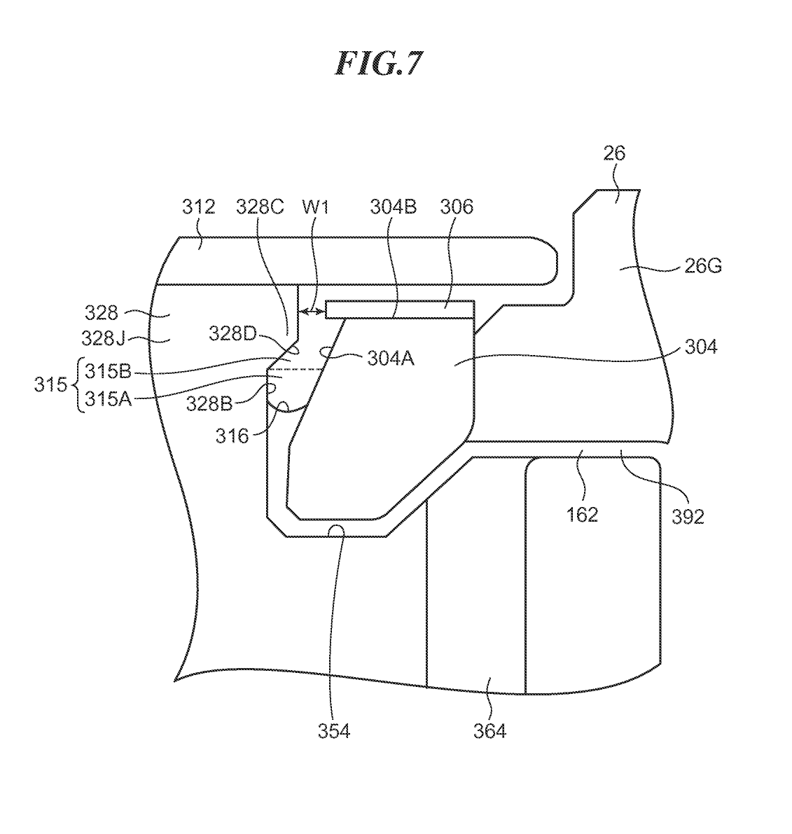

FIG. 7 is an enlarged cross-sectional view illustrating a nearby portion of the shaft ring 304 in FIG. 6. Formed between the shaft ring 304 and the shaft encircling portion 328J is the fifth capillary seal 315 that is a portion where the gap between an outer circumference 304A of the shaft ring 304 and opposing face 328B of the shaft encircling portion 328J facing the outer circumference 304A in the radial direction becomes gradually widespread toward the upper space. The fifth capillary seal 315 includes a fifth gas-liquid interface 316 of the lubricant 392.

The fifth capillary seal 315 includes a tapered area 315A where the fifth gas-liquid interface 316 is present when the rotator rotates relative to the stationary body, and a narrowed area 315B which is provided at a side of the fifth gas-liquid interface 316 where gas is present in communication with the tapered area 315A, and which suppresses a travel of the lubricant 392. The narrowed area 315B has a narrowed gap to suppress a travel of the lubricant 392.

A sealing upraised portion 328C that projects toward the shaft ring 304 is formed at a portion of the opposing face 328B of the shaft encircling portion 328J which forms the narrowed area 315B. The seal projection 328J includes a tapered side face 328D inclined inwardly toward the upper space. When the rotator is rotating, the droplets of the lubricant 392 spilled from the fifth gas-liquid interface 316 and sticking to the tapered side face 328D move downwardly by centrifugal force, and are returned to the fifth gas-liquid interface 316.

The seal cap 306 is fastened to an upper face 304B of the shaft ring 304 by bonding. The seal cap 306 extends toward the sealing upraised portion 328C. In particular, the seal cap 306 further extends outwardly from the outer edge of the upper face 304B of the shaft ring 304. A dimension W1 of the gap between the sealing upraised portion 328C and the seal cap 306 in the radial direction is smaller than the maximum dimension of the gap of the tapered area 315A in the radial direction. At least some lubricant 392 spilled from the fifth gas-liquid interface 316 when the rotator is rotating hit the projecting portion of the seal cap 306, and are returned to the fifth gas-liquid interface 316.

According to the rotating device 300 of this embodiment, the amount of lubricant 392 eventually dissipated when shock is applied to the rotating device 300 can be reduced. In particular, when shock wave due to shock applied to the upper face of the top cover 2 propagates through the bypass communication orifice 364 from the top to the bottom, most shock wave enters the damper portion 366 and are attenuated. Therefore, shock wave reaching the first capillary seal 114 can be weakened. As a result, the amount of lubricant 392 eventually dissipated from the first gas-liquid interface due to application of shock can be reduced.

According to this embodiment, the damper portion 366 is held between an opening 364A of the bypass communication orifice 364 and the first capillary seal 114. In contrast, according to the first and second embodiments, the opening of the bypass communication orifice is located between the gap serving as a damper and the capillary seal. Hence, the shock attenuating effect of the first and second embodiments is basically better than that of the third embodiment.

Still further, according to the rotating device 300 of this embodiment, as to the shape of the fifth capillary seal 315, the narrowed area 315B that suppresses a travel of the lubricant 392 to aside of the fifth gas-liquid interface 316 where gas is present is formed. In particular, the gap is further narrowed in the narrowed area 315B. Hence, the lubricant 392 spilled from the fifth gas-liquid interface 316 due to application of shock is not likely to pass through the narrowed area 315B, thus the amount of spilled lubricant 392 can be reduced.

The structure of the rotating device and the operation thereof according to the embodiments of the present invention were explained above. Those embodiments are presented merely as examples, and various modifications to a combination of respective structural components of the aforementioned embodiments are possible. It should be understood by those skilled in the art that such modifications are also within the scope and spirit of the present invention.

In the respective embodiments, the explanation was given of a so-called outer-rotor type rotating device having the cylindrical magnet 32 located outwardly relative to the laminated core 40, but the present invention is not limited to this structure. For example, the present invention is also applicable to a so-called inner-rotor type rotating device having the cylindrical magnet located inwardly relative to the laminated core.

The explanation was given of a case in which the laminated core is employed in the respective embodiments, but the core may be other types than the laminated type.

Although the explanation was given of a case in which the hub is formed of a ferrous material in the respective embodiments, the present invention is not limited to this case. For example, in order to reduce the weight of the hub, the hub may be formed of a non-ferrous metal material like an aluminum alloy, or may be formed of a resin material like a liquid crystal polymer.

In the respective embodiments, the explanation was given of a case in which the housing is engaged with the non-through-hole bearing recess formed in the upper face of the base, but the present invention is not limited to this case. For example, a through-hole may be provided in a portion corresponding to the bearing recess, and the housing may be fitted in that through hole and fixed thereto.

Although the explanation was given of an example case in which a ring member (e.g., the shaft ring 304) is a separate piece from the flange 26G, the shaft ring 304 may be formed integrally with the flange 26G.

What is claimed is:

1. A rotating device comprising:
a rotator on which a recording disk is to be mounted;
a stationary body that supports the rotator in a freely rotatable manner;
a dynamic pressure generating portion provided in a lubricant-retained area where a lubricant is to be retained in a gap between the rotator and the stationary body;
two capillary seals opened at respective ends of the lubricant-retained area;
a cover ring which rotates together with the rotator, and which covers an opening of either one of the two capillary seals; and
a cap structure which is provided in a space between the cover ring and the one capillary seal, and which is structured to reduce an amount of the lubricant spilled from the capillary seal and eventually dissipated when shock of substantially 1200 G is applied so as to be less than 5% of a total amount of the lubricant.

2. The rotating device according to claim 1, wherein the cap structure has a gap thereof becoming narrower than an open width of the one capillary seal to suppress a travel of the lubricant.

3. The rotating device according to claim 1, wherein:
the cap structure includes two surfaces facing with each other in a radial direction; and
one of the two surfaces comprises an upraised portion upraised toward the other surface.

4. The rotating device according to claim 3, wherein the cap structure is provided with an extending portion that extends from the other surface toward the upraised portion in the radial direction.

5. The rotating device according to claim 4, wherein:
the cover ring has an external side fastened to the rotator, and has an internal side facing with a side face of the stationary body and an end face thereof with respective gaps; and
the extending portion is fastened to the stationary body so as to face the cover ring with a gap.

6. The rotating device according to claim 4, wherein the extending portion has an internal end in the radial direction disposed so as to be more distant from a rotation center of the rotator than an internal end of the cover ring in the radial direction.

7. The rotating device according to claim 4, wherein:
the stationary body comprises a ring member that encircles a rotation center of the rotator; and
the ring member has an outer circumference where the one capillary seal between the two capillary seals is disposed, and has an end face at the cover-ring side fastened with the extending portion.

8. The rotating device according to claim 1, wherein:
either one of the rotator and the stationary body comprises a shaft that extends along a rotation axis of the rotator, and the other one of the rotator and the stationary body comprises a sleeve that encircles the shaft;
the sleeve is provided with a passage which bypasses the dynamic pressure generating portion and which has orifices opened at both of the two capillary seals;
the rotating device further comprises a damper area which is provided between the one capillary seal and the dynamic pressure generating portion in the lubricant-retained area, and which has a larger volume than a volume of the dynamic pressure generating portion; and
one of the orifices is opened at the damper area.

9. The rotating device according to claim 8, wherein the damper area serves as a lubricant retainer that retains thereinside the lubricant.

10. The rotating device according to claim 1, wherein:
either one of the rotator and the stationary body comprises a shaft that extends along a rotation axis of the rotator, and the other one of the rotator and the stationary body comprises a sleeve that encircles the shaft;
the sleeve is provided with a passage which bypasses the dynamic pressure generating portion and which has orifices opened at both of the two capillary seals; and
a length of the passage is equal to or shorter than a half of a maximum length of the sleeve in an axial direction.

11. A rotating device comprising:
a rotator on which a recording disk is to be mounted;
a stationary body that supports the rotator in a freely rotatable manner;
a dynamic pressure generating portion provided in a lubricant-retained area where a lubricant is to be retained in a gap between the rotator and the stationary body;
two capillary seals opened at respective ends of the lubricant-retained area;
a cover ring which rotates together with the rotator, and which covers an opening of either one of the two capillary seals;
a narrowed structure which is provided in a space between the cover ring and the one capillary seal, and which has a gap becoming narrower than an open width of the one capillary seal to suppress a travel of the lubricant;
wherein the narrowed structure comprises:
two surfaces facing with each other in a radial direction;
one of the two surfaces comprises an upraised portion upraised toward the other surface; and
an extending portion that extends from the other surface toward the upraised portion in the radial direction.

12. The rotating device according to claim 11, wherein:
the cover ring has an external side fastened to the rotator, and has an internal side facing with a side face of the stationary body and an end face thereof with respective gaps; and
the extending portion is fastened to the stationary body so as to face the cover ring with a gap.

13. The rotating device according to claim 11, wherein the extending portion has an internal end in the radial direction disposed so as to be more distant from a rotation center of the rotator than an internal end of the cover ring in the radial direction.

14. The rotating device according to claim 11, wherein:
the stationary body comprises a ring member that encircles a rotation center of the rotator; and
the ring member has an outer circumference where the one capillary seal between the two capillary seals is disposed, and has an end face at the cover-ring side fastened with the extending portion.

15. The rotating device according to claim 14, wherein:
the stationary body comprises a shaft that extends along a rotation axis of the rotator, and, a flange that extends outwardly in the radial direction from the shaft;
the rotator comprises a sleeve that encircles the shaft;
an annular sleeve recess is formed in an end face of the sleeve; and
the ring member enters the sleeve recess.

16. The rotating device according to claim 15, wherein:
the sleeve is provided with a passage which bypasses the dynamic pressure generating portion and which has orifices opened at both of the two capillary seals; and
one of the orifices of the passage faces at least one of the ring member and the flange in an axial direction.

17. A rotating device comprising:
a rotator on which a recording disk is to be mounted;
a stationary body that supports the rotator in a freely rotatable manner;
a dynamic pressure generating portion provided in a lubricant-retained area where a lubricant is to be retained in a gap between the rotator and the stationary body;
two capillary seals opened at respective ends of the lubricant-retained area; and
a cover ring which rotates together with the rotator, and which covers an opening of either one of the two capillary seals,
wherein:
at least either one of the two capillary seals comprises a suppressor located outwardly relative to an area where the lubricant is to be present, the suppressor being structured to suppress a travel of the lubricant.

18. The rotating device according to claim 17, wherein the suppressor has a gap thereof becoming narrower than an open width of the one capillary seal to suppress a travel of the lubricant.

19. The rotating device according to claim 17, wherein:
the suppressor includes two surfaces facing with each other in a radial direction; and
one of the two surfaces comprises an upraised portion upraised toward the other surface.

20. The rotating device according to claim 17, wherein a gap between the rotator and the stationary body includes a labyrinth seal formed of corresponding concavity and convexity;
the labyrinth seal is in communication with the suppressor through a lubricant trap that has a wider gap than a gap of the labyrinth seal; and
the lubricant trap traps the lubricant moved from the lubricant-retained area by centrifugal force when the rotator rotates relative to the stationary body.
